(19) United States
(12) Patent Application Publication
(10) Pub. No.: US 2025/0384380 A1
(43) Pub. Date: Dec. 18, 2025

(54) GENERATIVE AI ENABLED STORE EMPLOYEE ASSISTANCE PLATFORM

(71) Applicant: Target Brands, Inc., Minneapolis, MN (US)

(72) Inventors: Bharathi INAMPUDI, St. Paul, MN (US); Emma WILLARD, Minneapolis, MN (US); Seetharaman VENKATESAN, Minneapolis, MN (US); Prashanth HEGDE, Anoka, MN (US)

(21) Appl. No.: 19/242,234

(22) Filed: Jun. 18, 2025

Related U.S. Application Data
(60) Provisional application No. 63/661,556, filed on Jun. 18, 2024.

(51) Int. Cl. G06Q 10/0639; G06F 16/334; G06F 40/35; G06F 40/40; G06Q 10/067

(52) U.S. Cl. CPC G06Q 10/0639; G06F 16/3347; G06F 40/35; G06F 40/40; G06Q 10/067

(57) ABSTRACT

A store employee assistance platform is provided that is enabled with generative artificial intelligence to deliver role-specific, context-aware responses to natural language questions submitted by users, including store employees. The platform includes a store employee assistance application with a chat interface through which a user may submit a question. The platform identifies the user's role, store location, and access level, and retrieves relevant enterprise content from a vector database and historical data store. A prompt engine constructs a contextualized prompt incorporating the user's identity and the retrieved information, and submits the prompt to one or more generative AI models. The resulting response is tailored to the user's responsibilities and delivered through the chat interface, providing real-time operational guidance specific to the user's role within the retail environment.

### CROSS-REFERENCE TO RELATED APPLICATIONS

The present application claims priority from U.S. Provisional Patent Application No. 63/661,556, filed on Jun. 18, 2024, the disclosure of which is hereby incorporated by reference in its entirety.

### BACKGROUND

Retail organizations employ workers in a variety of roles, including point of sale workers, restockers, online order fulfillment workers, managers/supervisors, and the like. Each of these individuals has his/her own set of roles and responsibilities. As such, it is often the case that individuals among each of these groups may have a different perspective on issues that arise in an organization. Where a technical issue with a transaction at a point of sale issue may appear as an issue requiring assistance to a main point of sale worker, it may need to be tended to by technical personnel, or may suggest to supervisors that other points of sale or methods of purchase may need to be used. In the context of an online order, personnel may need to be able to check a status of an order, find the order for purposes of fulfillment, and the like.

Increasingly, information access systems have been developed to assist employees with identifying relevant information to issues encountered during the day. Such systems have included chat bot style systems in which a user may submit questions within a user interface of a web or mobile application, and receive responsive answers, if available. While such systems provide employee convenience, they are limited in applicability. In particular, such systems are well adapted to information lookup tasks, such as identifying order status or stocking status of a given item, but are poorly suited to a variety of other types of information sought by an employee. Accordingly, these solutions are of generally limited use.

### SUMMARY

In accordance with the present disclosure, a store employee assistance platform is provided that is enabled with generative artificial intelligence. Such a system is configured for use with enterprise data, and is responsive to a wide variety of questions posed by employees having different roles within an organization. Responsive information is tailored to the employee role, while being flexible to be responsive to a wide variety of questions posed by that employee.

In a first aspect, a store employee assistance system is disclosed. The store employee assistance system comprises: a chat interface configured to receive a query from a user via a user application; a vector database configured to store vectorized enterprise data associated with an enterprise; a chat service communicatively coupled to the chat interface and the vector database, the chat service configured to: determine one or more user attributes and contextual information associated with the query; retrieve relevant content from the vector database based on semantic similarity between the query and the vectorized enterprise data; generate a prompt combining the query and the relevant content; a generative artificial intelligence system configured to formulate a response to the query based on the prompt, the user attributes, and the contextual information; and wherein, the chat service is further configured to provide the response to the chat interface for display to the user.

In a second aspect, a method for providing assistance to users is disclosed. The method comprises: receiving, at a chat interface, a query from a user via a user application; storing vectorized enterprise data associated with an enterprise in a vector database; determining, by a chat service, one or more user attributes and contextual information associated with the query; retrieving, by the chat service, relevant content from the vector database based on semantic similarity between the query and the vectorized enterprise data; generating, by the chat service, a prompt combining the query and the relevant content; formulating, using a generative artificial intelligence system, a response to the query based on the on the prompt, the user attributes, and the contextual information; and providing the response to the chat interface for display to the user.

In a third aspect, a store employee assistance system is disclosed. The store employee assistance system comprises: a chat interface configured to receive a query from a user via a user application; a document uploader configured to parse, vectorize, and store enterprise data associated with an enterprise into a vector database. a chat service communicatively coupled to the chat interface and the vector database, the chat service configured to: determine an identity of the user, a role of the user within the enterprise and access rights associated with the user retrieve relevant content from the vector database based on semantic similarity between the query and the vectorized enterprise data; generate a prompt combining the query and the relevant content; a generative artificial intelligence system configured to formulate a response to the query based on the prompt, the user attributes, and the contextual information wherein the response is customized by the generative artificial intelligence system to align with one or more of: the role of the user within the enterprise and with the access rights associated with the user; and wherein, the chat service is further configured to: store, in a historical database: the query, the prompt, the response, session metadata comprising one or more of: user identity, timestamp, and session identifier, the relevant content used to generate the response, and model metadata associated with the generative AI system; and provide the response to the chat interface for display to the user on the user application.

### BRIEF DESCRIPTION OF THE DRAWINGS

FIG. 1 illustrates an example environment in which aspects of the present disclosure may be implemented.

FIG. 2 illustrates a generalized architecture of a store employee assistance platform, in accordance with an example embodiment.

FIG. 3 illustrates a general data flow diagram showing a process for data ingestion and submission to one or more generative AI systems, in accordance with an example embodiment.

FIG. 4 illustrates a data flow showing processing of a question received at a chatbot using enterprise data to format generative AI prompts, according to an example embodiment.

FIG. 5 illustrates an example data flow showing processing of help and topical information requests received at a user interface causing formatting of generative AI prompts, according to an example embodiment.

FIG. 6 illustrates capturing a feedback request provided at a mobile application based on the quality of a response provided, in accordance with an example embodiment.

FIG. 7 illustrates capturing a feedback response provided at a user interface based on the quality of a response provided, in accordance with an example embodiment.

FIG. 8 illustrates an example computing system with which aspects of the present disclosure can be implemented.

### DETAILED DESCRIPTION

The present disclosure is directed to systems and methods for providing intelligent, context-aware assistance to retail store employees using generative artificial intelligence (AI). More specifically, the disclosure relates to a platform that leverages generative AI (Gen AI) models and enterprise-specific knowledge sources to deliver real-time, role-sensitive responses to employees' operational and procedural inquiries. The system integrates natural language interfaces, enterprise content ingestion pipelines, and prompt generation mechanisms to facilitate efficient and accurate communication between employees and the organization's knowledge assets. The platform is particularly suited for deployment in large-scale, multi-location retail environments where consistent and immediate guidance can improve productivity and reduce dependency on manual support channels.

Retail employees frequently encounter questions related to store procedures, operational best practices, and policy compliance during their workday. Traditionally, to resolve such queries, employees must search through static documentation on internal portals, consult supervisors, or submit help requests via customer relationship management systems often leading to long wait times and fragmented support. These legacy systems are limited in responsiveness, accessibility, and personalization. Furthermore, existing chatbot solutions typically provide fixed decision-tree responses and cannot handle open-ended or context-sensitive queries effectively. Accordingly, there exists a need for a more dynamic, scalable, and contextually intelligent solution to support store employees in real time.

The present disclosure addresses this need through a generative AI-enabled store employee assistance platform. The disclosed system allows users to enter questions in natural language through a chat interface, typically accessed via a mobile or web-based application. The system then interprets the query, identifies the user's role and context, and dynamically assembles a tailored prompt using vectorized enterprise data. The prompt is submitted to one or more generative artificial intelligence (“GenAI”) models via an intermediary API interface, and the resulting response is returned to the user in a concise, role-appropriate format. This closed-loop interaction enables immediate, accurate assistance without the need for manual escalation or search.

The disclosed platform is built upon a multi-layered architecture consisting of a front-end chat interface, a back-end chat service, a document ingestion pipeline, and a vector database. The ingestion pipeline extracts content from enterprise sources such as SharePoint, PDF files, and Word documents, and transforms this content into vector representations using a configurable chunking process. These vectors are indexed in a search-based database and refreshed periodically to maintain current and relevant knowledge. When a user submits a query, a vector store service identifies the most relevant content chunks based on semantic similarity, and the prompt engine combines those chunks with predefined instructions and context to generate a prompt suitable for submission to a GenAI model via an API.

The system supports dynamic configuration of both the chunking parameters and the underlying AI model selection, enabling flexible adaptation based on query type or enterprise requirements. In addition to responding to user queries, the system captures user feedback, such as thumbs-up/down responses and textual comments, which are stored in a post-processing database. This feedback, along with query and response logs, is used to perform topic analysis and inform iterative improvements to prompt engineering and system performance. The prompt engine incorporates carefully constructed instructions that enforce concise formatting, domain-specific tone, and avoidance of unsupported or hallucinated content. Furthermore, the system allows for context preservation across limited conversational turns by including prior question-answer pairs within the prompt where feasible.

The disclosed approach provides significant technical and operational advantages Eover traditional help systems. By combining real-time vector-based retrieval with context-sensitive prompt formulation, the system ensures fast and accurate delivery of relevant information tailored to each employee's role and context. Unlike decision-tree chatbots or static documentation, the disclosed system dynamically interprets and responds to open-ended questions, reducing time spent searching or waiting for support. The ability to ingest, index, and serve enterprise content in near-real-time enhances knowledge accessibility and keeps support material current. Additionally, the integration of user feedback and topic analytics fosters continuous system improvement, offering a scalable and adaptive support mechanism for modern retail operations.

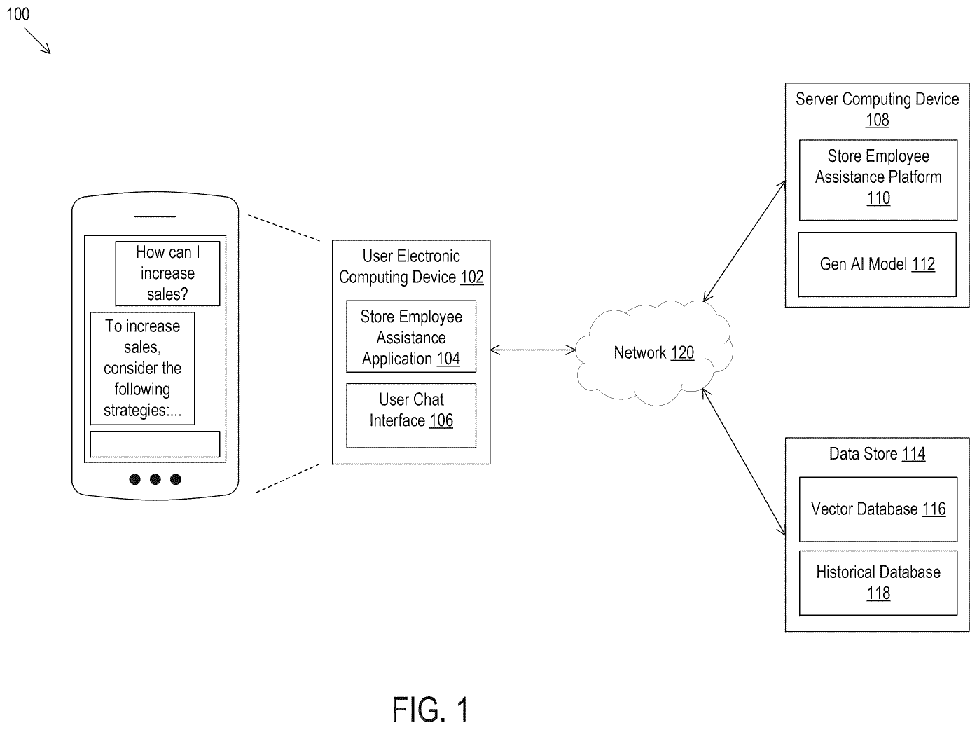

FIG. 1 illustrates an example configuration of store employee assistance system 100. The store employee assistance system 100 is configured to receive natural language queries from a user device via a chat interface, process those queries using enterprise data and generative AI components, and return contextually tailored responses to the user. The store employee assistance system 100 may include a user electronic computing device 102, a server computing device 108 including a store employee assistance platform 110 and Gen AI model 112, a data store 114, and a network 120.

The user electronic computing device 102 of FIG. 1 represents a personal computing device used by a store employee of a retail enterprise to interact with the store employee assistance platform 110. The user electronic computing device 102 may be, for example, a smartphone, tablet, laptop, or other portable or desktop computing device capable of executing applications and rendering user interfaces. The user of the device is typically a retail employee, such as a cashier, restocker, floor associate, or store supervisor, or a contractor associated with the enterprise who utilizes the system to obtain timely assistance with tasks, procedures, or questions encountered during daily store operations. However, other types of users associated with the enterprise can also use the user electronic computing device 102. The user electronic computing device 102 may include a store employee assistance application 104, which hosts a user chat interface 106 that enables the user to input natural language questions. The store employee assistance application 104 may be installable on devices associated with different users located at geographically dispersed sites across a retail enterprise.

The user electronic computing device 102 may be configured to communicate with a server computing device 108 over a network 120 to access a store employee assistance platform 110. The store employee assistance platform 110 may be configured to process the user's question using enterprise-specific vectorized content and one or more Gen AI models 112 to generate a contextually relevant and role-appropriate response. The resulting response may be returned to the user electronic computing device 102 and presented to the user via the store employee assistance application 104. The store employee assistance platform 110 may analyze the user's question, determine a question intent and user role based on contextual attributes such as location, session metadata, and stored enterprise data, and formulate a tailored response accordingly.

For example, using the user chat interface 106, a user may ask questions related to rules, policies, procedures, or operational guidance—such as how to manage a pricing override, how to process a return outside of standard policy, or how to locate documentation for merchandise stocking. In one illustrative example depicted in FIG. 1, a user may use a mobile device to type the question, “How can I increase sales?” into the user chat interface 106. The user chat interface 106 may display a response received from the store employee assistance platform 110, the response including targeted strategies and insights drawn from enterprise knowledge tailored to the user's role. For a supervisor, this may include staffing or cleanliness initiatives; for a floor associate, it may include tips on item restocking or customer engagement. Other questions may be more operational or scenario-based in nature, such as inquiries like “my application has disappeared—what can I do?” or “does our bottling vendor need a detailed check-in?” or “can I dump alcohol in a sink?” The system may respond to such open-ended queries by identifying and retrieving relevant documentation or policy information from enterprise sources.

The server computing device 108 of FIG. 1 may be hosted by a retail enterprise and may be configured to provide backend processing, orchestration, and artificial intelligence (AI)-enabled response generation services for the store employee assistance system 100. The server computing device 108 may be implemented as a physical server, a virtualized environment, or a distributed system depending on the enterprise's deployment architecture. In an example, the server computing device 108 hosts a store employee assistance platform 110, and hosts or provides an access interface to GenAI model 112, each of which plays a distinct role in enabling automated, context-aware support for the user.

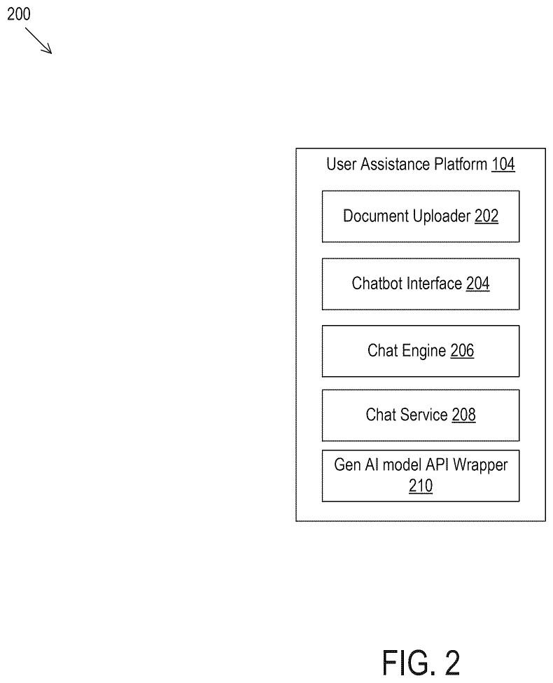

The store employee assistance platform 110 may include multiple subsystems that collectively perform functions such as query reception, context aggregation, document retrieval, prompt generation, GenAI model 112 interaction, and response delivery. The store employee assistance platform 110 may also coordinate document ingestion from enterprise repositories and maintain historical usage data. The store employee assistance platform 110 is described in further detail in relation to FIGS. 2-7.

The GenAI model 112 may be trained on a wide variety of data sources to support natural language understanding and generation capabilities. In an example, the Gen AI model 112 may be trained on general-purpose corpora including books, websites, encyclopedic references, and technical documentation to develop a foundational understanding of language, syntax, and semantics. Additionally, the GenAI model 112 may be further fine-tuned on enterprise-specific content, such as internal process documentation, policies, procedures, best practices, training manuals, and historical support cases, to ensure relevance and accuracy within a retail operational context.

For example, The GenAI model 112 may be configured to accept contextual input, such as a user's role or store location, and generate concise, task-appropriate responses using both general knowledge and enterprise-specific embeddings. The GenAI model 112 may be hosted locally on the server computing device 108, or alternatively accessed through secured external APIs, depending on system architecture and performance requirements. In some examples, the GenAI model 112 may include one or more large language models (LLMs) such as include GPT-4, GPT-4o (available from OpenAI), Claude (available from Anthropic), LLaMA (available from Meta), Mixtral, and others. In other examples, the GenAI model 112 may include other multimodal models.

Although FIG. 1 illustrates a single user electronic computing device 102 communicatively connected to the server computing device 108, in practice, there may be hundreds, thousands, or even more such user devices simultaneously connected to and served by the server computing device 108. These user electronic computing devices may each be operated by different users across various locations in a retail enterprise. The server computing device 108 may support scalable interactions with these devices in parallel, ensuring consistent access to responsive and personalized assistance functionality throughout the enterprise.

The data store 114 of FIG. 1 refers to one or more storage systems or repositories configured to retain structured and unstructured data used by the store employee assistance platform 110. In an example, the data store 114 may be implemented using on-premise databases, cloud-based storage services, or hybrid infrastructure. The data store 114 may include multiple logically or physically distinct components, including a vector database 116 and a historical database 118.

The vector database 116 may be configured to store enterprise documentation that has been ingested, parsed, and transformed into vectorized format. These vectors may represent semantically meaningful embeddings of text extracted from internal sources such as SharePoint pages, PDFs, Word documents, and other policy and procedure repositories. The vector database 116 may support similarity search operations, allowing for rapid retrieval of relevant content based on a user's natural language query. During runtime, the vector database 116 may be queried by the store employee assistance platform 110 to identify content chunks most relevant to a user-submitted question, which are then included in prompts submitted to the Gen AI model 112 for response generation.

The historical database 118 may be configured to store records of prior user interactions with the system, including submitted queries, generated responses, session metadata, and user feedback. In an example, the historical database 118 may store user identifiers, timestamps, chat session context, and approval or disapproval ratings for returned answers. The historical database 118 may be used for performance monitoring, analytics, topic clustering, and to inform iterative improvement of prompt engineering and knowledge coverage.

In some examples, the store employee assistance platform 110 may access the vector database 116 to retrieve semantically similar content needed to formulate contextually relevant responses, and may access the historical database 118 to evaluate prior interactions, track usage patterns, and incorporate conversational history where applicable.

The network 120 is a computer network, such as a local area network, a wide area network, the Internet, or a mixture thereof. The user on the user electronic computing device 102 can receive information for display as part of the store employee assistance application 104 on a user interface of the user electronic computing device 102, including information from the store employee assistance platform 108 via the network 120. In other examples, the network 102 may include another type of computer network that enables communication between the user electronic computing device 102, the server computing device 108, and the data store 114.

FIG. 2 illustrates an example implementation 200 of the store employee assistance platform 104 from FIG. 1. The store employee assistance platform 104 is configured to receive natural language queries from a user, retrieve relevant enterprise content, generate structured prompts using contextual data, and interact with one or more generative AI models to return tailored, role-specific responses for display on a user interface.

The document uploader 202 of the store employee assistance platform 104 may be configured to receive enterprise documents from one or more data connectors and prepare the contents of those documents for inclusion in a vectorized enterprise knowledge base. In an example, the document uploader 202 may access structured or unstructured data sources, including internal repositories, SharePoint directories, PDF files, Word documents, HTML pages, or other content formats defined by the retail enterprise. The document uploader 202 may perform a document parsing process to extract relevant textual and image-based content, and may apply optical character recognition (OCR) and image recognition techniques to convert such content into machine-readable formats.

Following extraction, the document uploader 202 may segment the content into a plurality of discrete data chunks according to configurable size and boundary parameters. The content chunks may then be transformed into semantic vector embeddings using a selected embedding model. The resulting vectors may be stored in a vector database 116 to support downstream similarity search and retrieval operations by other components of the store employee assistance platform 104. In an example, the document uploader 202 may operate periodically or in response to defined update events, enabling the platform to maintain an up-to-date representation of relevant enterprise knowledge.

The chat interface 204 of the store employee assistance platform 104 may be configured to receive natural language input from a user via the user chat interface 106 of the user electronic computing device 102. The chat interface 204 may serve as an intermediary communication layer that facilitates structured transmission of user-submitted questions to backend services of the store employee assistance platform 104. In an example, the chat interface 204 may be configured to perform pre-processing operations on the received input, such as sanitization, normalization, tokenization, or encoding, to prepare the content for downstream processing.

Once pre-processing is completed, the chat interface 204 may forward the structured question data, along with associated session metadata, to the chat engine 206 for further handling. The session metadata may include a user identifier, a store location, a time stamp, a session ID, or other contextual attributes useful for personalizing the response. In addition, the chat interface 204 may be configured to receive a response generated by the chat engine 206, and re-format or adapt the output prior to display in the user chat interface 106. In an example, re-formatting may include restructuring text for readability, enforcing enterprise tone or style guidelines, truncating overly long responses, or embedding supporting metadata, such as sources or confidence indicators, to enhance interpretability for the end user.

The chat engine 206 may be configured to serve as the central orchestration component within the store employee assistance platform 104 for managing conversational interactions between a user and backend systems. Upon receiving a structured query and associated session metadata from the chat interface 204, the chat engine 206 may initiate a communication session and coordinate the retrieval and aggregation of relevant data needed to formulate a prompt for a generative AI model. In an example, the chat engine 206 may extract and temporarily store contextual information such as the user's role, store identifier, prior question history, and time of interaction to inform downstream processing.

The chat engine 206 may transmit the user's query and session context to the chat service 208, which is responsible for preparing and submitting a full prompt to a generative AI model. Once a response is received from the chat service 208, the chat engine 206 may validate, log, and format the returned content, and then send the processed response back to the chat interface 204 for reformatting and delivery to the user chat interface 106. In addition, the chat engine 206 may manage session continuity, error handling, performance tracking, and logging of conversational metadata for later analysis by administrative or diagnostic subsystems of the platform.

The chat service 208 may be configured to act as the primary backend processing engine within the store employee assistance platform 104 for generating responses to user-submitted queries. Upon receiving a user question and associated session metadata from the chat engine 206, the chat service 208 may retrieve relevant contextual content from a vector database 116, including semantically similar text segments derived from enterprise documentation. In an example, the chat service 208 may also supplement the query with role-based or location-specific data to ensure the prompt reflects the operational context of the user.

The chat service 208 may aggregate the user query, the retrieved contextual data, and structured prompt instructions into a unified prompt, which is then submitted to the GenAI model 112 through the GenAI model API wrapper 210. Upon receiving a generated response from the GenAI model 112, the chat service 208 may optionally perform validation, enrichment, or confidence filtering operations before returning the response to the chat engine 206. The chat service 208 may also be responsible for storing or forwarding session data, including the original query, selected context chunks, generated response, and any user feedback, to the historical database 118 for tracking, analysis, and continuous improvement of platform performance.

The GenAI model API wrapper 210 of the store employee assistance platform 104 may be configured to serve as an interface layer between the chat service 208 and the Gen AI model 112. The GenAI model API wrapper 210 may be responsible for managing the formatting, routing, and submission of structured prompts generated by the chat service 208 to an appropriate generative AI model. In an example, the GenAI model API wrapper 210 may include configuration logic to select among the multiple available models within the Gen AI model 112 based on criteria such as model capabilities, usage quotas, response latency, or enterprise preferences.

In an example, the GenAI model API wrapper 210 may be implemented using an interface such as described in U.S. Provisional Patent Application No. 63/561,109, filed on Mar. 4, 2024, and U.S. application Ser. No. 19/070,120, filed on Mar. 4, 2025, the disclosures of which is hereby incorporated by reference in its entirety.

The GenAI model API wrapper 210 may be compatible with a variety of hosted or externally accessible models, including GPT-4, GPT-4o (available from OpenAI), Claude (available from Anthropic), LLaMA (available from Meta), Mixtral, or other transformer-based models. Upon receiving a response from the selected model of the Gen AI model 112, the GenAI model API wrapper 210 may validate the response format, extract any metadata (e.g., model version, token usage), and return the response payload to the chat service 208 for downstream processing. In an example, the GenAI model API wrapper 210 may also enforce enterprise-level content filtering, prompt safety constraints, or model-specific access controls prior to execution of the query.

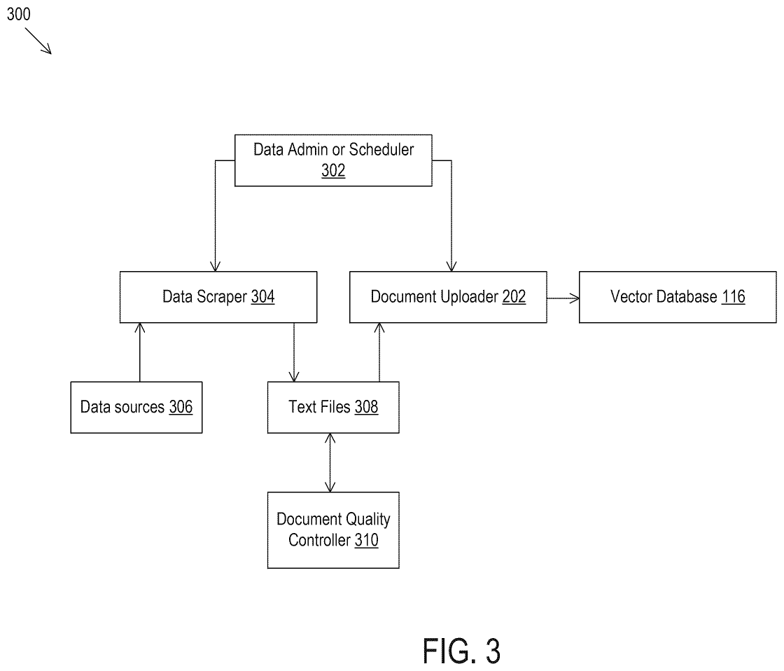

FIG. 3 illustrates an example data flow diagram 300 showing a process for data ingestion by the document uploader from FIG. 2 in accordance with an example embodiment. The example data flow diagram 300 includes a data admin or scheduler 302, a data scraper 304, one or more data sources 306, text files 308, a document quality controller 310 that are used by the document uploader 202 to extract appropriate enterprise data and store the extracted data in the vector database 116.

The data administrator or scheduler 302 may be configured to define, manage, and initiate data ingestion workflows for incorporating enterprise documentation into the store employee assistance platform 104. In an example, the data administrator or scheduler 302 may be a human operator, such as an IT specialist, platform engineer, or enterprise knowledge manager, who is responsible for overseeing the completeness and freshness of the content used to support user interactions. Alternatively, or in addition, the data administrator or scheduler 302 may be an automated software agent or orchestration service configured to initiate ingestion jobs based on defined triggers, schedules, or conditions.

The data administrator or scheduler 302 may create and manage one or more ingestion tasks that identify source data locations, specify target processing pipelines, and define metadata tagging, access permissions, and scheduling policies. Scheduling policies may include static time-based schedules (e.g., daily at midnight, every Sunday at 2 AM), frequency-based schedules (e.g., every 6 hours), or dynamic, event-driven schedules (e.g., upon file modification, document publication, or API webhook notification). The ingestion jobs may be stored as task configurations and submitted to a processing queue or job dispatcher.

In some examples, the data administrator or scheduler 302 may be realized using enterprise scheduling tools (e.g., Airflow, CRON jobs, AWS EventBridge, Azure Data Factory), or embedded within a custom administrative interface of the platform. The component may provide reporting or audit capabilities to track ingestion history, job completion status, and ingestion errors. Once a job is triggered, the scheduler may pass control to the data scraper 304, providing job metadata such as document source paths, expected file formats, extraction rules, and version control policies.

Upon initiating an ingestion task, the data administrator or scheduler 302 may transmit configuration metadata to both the data scraper 304 and the document uploader 202 to guide the execution of the ingestion workflow. The data sent to the data scraper 304 may include identifiers for target data sources (e.g., SharePoint URLs, GitHub repositories, network directories), authentication credentials or access tokens, file format filters, and scraping directives such as depth of traversal, file type inclusions, and recursion rules. Concurrently, the data administrator or scheduler 302 may provide the document uploader 202 with ingestion job parameters such as chunking policies, vectorization model selection, metadata tagging schemas, OCR configuration settings, and document classification rules. These parameters enable both the data scraper 304 and the document uploader 202 to operate in a coordinated manner, ensuring that extracted documents are parsed, processed, and transformed into semantically meaningful vector embeddings suitable for storage in the vector database 116.

The data scraper 304 may be configured to retrieve raw data files from designated enterprise repositories and other information sources, as specified by the data administrator or scheduler 302. Upon receiving an ingestion configuration from the data administrator or scheduler 302, the data scraper 304 may extract operational parameters such as source identifiers, access credentials, scraping depth, file type filters, directory traversal logic, and rate-limiting constraints. These parameters define how and from where the data scraper 304 should retrieve documents and in what formats or structure.

Based on the received configuration, the data scraper 304 may initiate queries or file access operations against one or more data sources 306, which may include cloud-based platforms (e.g., SharePoint, Google Drive, Dropbox), enterprise content management systems (e.g., Confluence, Documentum), code repositories (e.g., GitHub, GitLab), network file systems, or internal databases. The data scraper 304 may send HTTP requests, API calls, authenticated file reads, or command-line instructions depending on the nature of the data source 306. For example, if configured to interact with SharePoint, the data scraper 304 may use RESTful API calls or Microsoft Graph APIs to retrieve.aspx page content, metadata, or file attachments. If integrated with a GitHub repository, the scraper may use GitHub's API to list and download Markdown files, PDFs, or YAML configuration documents from a specified branch or directory.

Upon retrieving content from the data sources 306, the data scraper 304 may organize the collected files into a temporary structured format for downstream processing. In an example, the scraper may preserve metadata such as source URL, file path, file type, last modified date, author, and access control list (ACL) information. The retrieved content may include diverse file types such as PDF documents, DOCX files, HTML pages, plaintext logs, and JSON configuration files. The data scraper 304 may perform optional pre-cleaning operations on the raw data such as format normalization, character encoding standardization (e.g., UTF-8), or removal of unsupported binary artifacts.

After collecting and optionally organizing the raw data, the data scraper 304 may output the retrieved documents and associated metadata to a designated intermediate storage location, represented in FIG. 3 as text files 308. In some examples, the text files 308 may be stored in the data store 114. The text files 308 may serve as a staging layer between extraction and ingestion, allowing for inspection, validation, or transformation by the document uploader 202. The data passed to the text files 308 may include both the textual content of each file and structured metadata that informs subsequent parsing, chunking, and vectorization operations. The entire process may be scheduled to run periodically or on-demand, enabling dynamic synchronization of enterprise knowledge with the store employee assistance platform 104.

The document quality controller 310 may be configured to evaluate and enforce content integrity, formatting standards, and data quality requirements on the intermediate documents stored in the text files 308. After the data scraper 304 outputs extracted documents and metadata to the text files 308, the document quality controller 310 may retrieve each document for validation and pre-ingestion analysis. The document quality controller 310 may serve as a quality gate within the data ingestion pipeline, ensuring that only documents meeting predefined thresholds for completeness, clarity, and content structure are passed on to the document uploader 202 for further processing.

In an example, the document quality controller 310 may assess document structure to ensure the presence of recognizable headers, logical sectioning, and readable formatting. The document quality controller 310 may also detect issues such as excessive noise (e.g., repeated boilerplate text), low text density, corrupted encoding, or unsupported file types. The document quality controller 310 may flag documents that fail validation checks, log issues for administrative review, or exclude such documents from ingestion altogether. Additional checks may include minimum content length, presence of required metadata fields, language consistency, and detection of redundant or duplicate content across documents.

The document quality controller 310 may also optionally enrich validated documents by normalizing formatting (e.g., consistent heading styles), correcting OCR-derived errors, or tagging documents with classification labels (e.g., topic type, department source). Once a document is verified and, if necessary, enhanced, the document quality controller 310 may mark it as “approved” for ingestion and update the text files 308 with the cleaned content or directly pass the cleaned content to the document uploader 202 along with associated metadata.

The document uploader 202 may be configured to retrieve cleaned and validated documents along with associated metadata from either the text files 308 or directly from the document quality controller 310, depending on the configuration of the ingestion pipeline. In an example, the document uploader 202 may operate in a pull-based mode, polling the text files 308 for newly marked or approved documents, or in a push-based mode, receiving content directly from the document quality controller 310 upon completion of quality checks. The retrieved data may include not only the body text of the documents but also structured metadata such as document title, source identifier, ingestion timestamp, document type, content category, and access permissions.

Once retrieved, the document uploader 202 may parse the content into discrete semantic units or “chunks” using a configurable segmentation policy. Each chunk may then be processed using a selected embedding model—such as BERT, SentenceTransformers, or a custom-trained encoder—to generate vector representations that capture the underlying semantic meaning of the text. The document uploader 202 may also attach metadata to each chunked vector, such as the document identifier, source location, access permissions, vector creation time, and any classification labels applied during quality control.

After vectorization, the document uploader 202 may transmit the resulting embeddings and associated metadata to the vector database 116 within the data store 114. The vector database 116 may be configured to support semantic search, similarity scoring, and filtering operations used by downstream components of the store employee assistance platform 104, such as the chat service 208. In an example, the document uploader 202 may log ingestion success or failure events, notify the data administrator or scheduler 302, and update versioning records to maintain synchronization across multiple ingestion cycles. This process enables the continuous, structured population of the enterprise knowledge base with high-quality, searchable vectorized content.

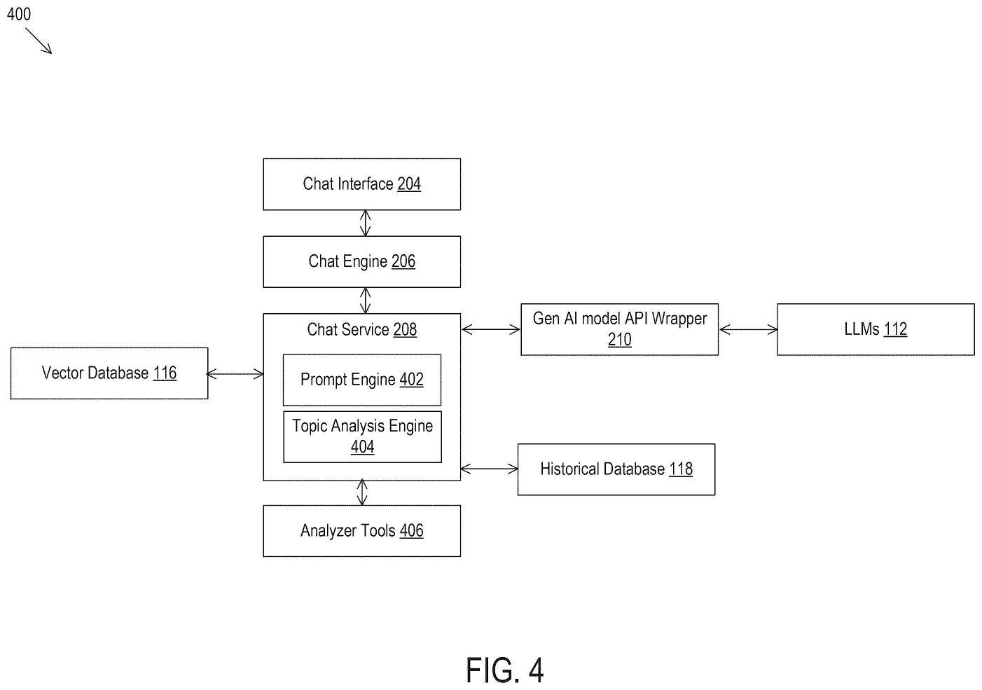

FIG. 4 illustrates an example flow diagram 400 of processing of a question received at the user chat interface 106 from FIG. 1, according to an example embodiment. The example flow diagram 400 includes operations by the chat interface 204, the chat engine 206, the chat service 208, analyzer tools 406, GenAI model API wrapper 210 and GenAI model 112. In addition to retrieving data from the vector database 116 to answer a question received from the user chat interface 106, the example flow diagram 400 also describes the storing of the question and corresponding response in the historical database 118 for downstream analysis.

The chat interface 204 may serve as the initial processing component responsible for receiving user-submitted queries from the user chat interface 106 and preparing those queries for downstream interpretation by the store employee assistance platform 104. In an example, when a user—such as a store associate, team lead, or supervisor—enters a question into the user chat interface 106, the chat interface 204 may act as the entry point for capturing the input, extracting relevant user session metadata, and initiating the information retrieval and prompt construction workflow.

The chat interface 204 may be implemented as a middleware service or API gateway that normalizes input from various front-end environments, including native mobile applications, web browsers, or in-store kiosks, depending on deployment architecture. Upon receiving a user query, the chat interface 204 may parse the message and extract session-level attributes such as user identifier, job title, access role, location code, and device ID. These attributes may be embedded in a structured request object that is ultimately forwarded to the prompt engine 402 for personalized processing. In an alternate implementation, the chat interface 204 may include client-side logic for lightweight pre-validation of the query (e.g., length checks, prohibited phrases) or may support multi-turn interactions by storing limited conversational history in memory or short-term cache.

As a key gateway to the AI-driven workflow illustrated in FIG. 4, the chat interface 204 plays a role in aligning user intent with contextual understanding. For example, if two users submit identical queries—such as “How can I manage order exceptions?”—the chat interface 204 may ensure that the downstream system receives not only the text of the question but also the user's identity and enterprise profile. This identity metadata is critical for determining whether the response should address order fulfillment tasks relevant to a backroom team member, procedural escalation steps for a shift lead, or operational tracking metrics for a supervisor. These distinctions are carried forward by the prompt engine 402, which uses identity-linked information to retrieve and assemble relevant content from the vector database 116.

The data used to generate these tailored responses originates from enterprise knowledge repositories that were previously ingested, parsed, and vectorized through the ingestion workflow depicted in FIG. 3. As such, the chat interface 204 enables intelligent reuse of curated enterprise content, ensuring that the response returned to the user chat interface 106 is not only accurate and context-specific, but also role-appropriate based on enterprise-defined access controls and organizational structure. Once the response has been generated, the chat interface 204 may optionally reformat or adapt the response—e.g., into bullet points, concise action steps, or reference links—before transmitting it back to the user electronic computing device 102 for display within the store employee assistance application 104.

The chat engine 206 may serve as a central orchestration layer that manages session-level processing and directs the flow of user-submitted questions through the store employee assistance platform 104. When a user enters a query into the user chat interface 106, the message is initially received and normalized by the chat interface 204, then forwarded to the chat engine 206 along with accompanying session metadata. The chat engine 206 may be configured to receive this structured input and initiate a contextual processing sequence that incorporates both enterprise knowledge and user-specific attributes to tailor the response.

In an example, the chat engine 206 may capture and cache user session data including the user's job title, department role, store location, organizational unit, and access permissions. These attributes may be used not only to guide what content is retrieved downstream but also to enforce access-based constraints on what knowledge segments may be referenced in a response. For instance, if the query is submitted by a front-line team member, the chat engine 206 may mark the session with restrictions that filter out content intended for store managers or corporate staff. Conversely, if the user is a team lead, additional procedural data or escalation protocols may be made available for retrieval.

After session enrichment, the chat engine 206 may dispatch the request to the prompt engine 402 of the chat service 208, along with the complete context package. The prompt engine 402 may be responsible for retrieving relevant content chunks from the vector database 116, which was populated using the ingestion and vectorization pipeline described in FIG. 3. Because the knowledge base has been segmented and vectorized with enterprise-specific semantics—including tagging based on department, job function, and operational procedures—the chat engine 206 ensures that the prompt engine has access to a user-tailored context that maximizes retrieval relevance.

In an alternate implementation, the chat engine 206 may also maintain conversational state across multiple interactions within a single session. For example, if a user submits a follow-up question such as “What if the guest refuses the exchange?” immediately after an earlier return policy inquiry, the chat engine 206 may associate the second query with the preceding context, allowing for a more coherent, scenario-aware response. Once the downstream Gen AI model 112 generates a response—delivered through the Gen AI model API wrapper 210 and chat service 208—the chat engine 206 may log the session data, response content, and any model metadata before returning the finalized result to the chat interface 204 for delivery to the user.

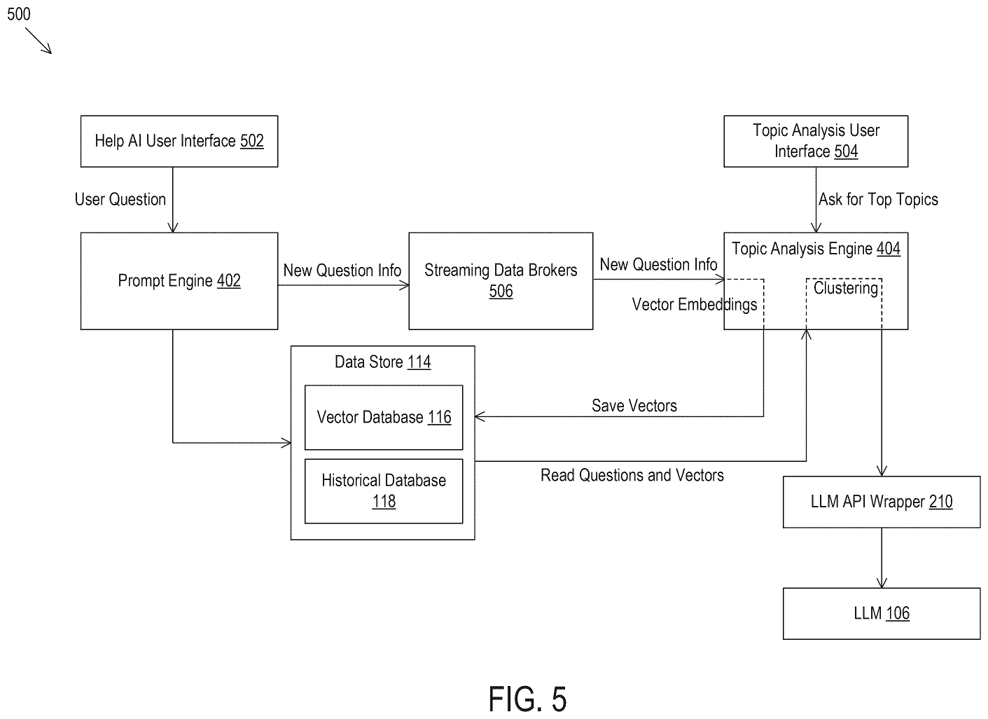

The chat service 208 may serve as the backend execution environment for intelligent prompt generation, Gen AI model response orchestration, and topic-level query handling within the store employee assistance platform 104. The chat service 208 may include two integrated components: a prompt engine 402, which performs content retrieval and prompt construction, and a topic analysis engine 404, which identifies and clusters emergent discussion themes. These components are described in further detail in FIG. 5. The chat service 208 operates downstream of the chat engine 206 and upstream of the Gen AI model API wrapper 210, functioning as the core logic unit for processing both individualized help queries and topical analysis requests.

In an example, when the chat service 208 receives a user-submitted question from the chat engine 206, the prompt engine 402 may first query the vector database 116 to retrieve semantically relevant document chunks previously ingested via the workflow illustrated in FIG. 3. The retrieval process may apply similarity search algorithms using the same embedding model used during ingestion, ensuring that the most contextually relevant enterprise data is identified. The prompt engine 402 may tailor the retrieval scope using user-specific metadata, such as job title, department, and access level, to filter results and enforce role-based visibility.

After relevant content is retrieved, the prompt engine 402 may assemble the document chunks, the user's original question, and identity-linked metadata into a structured prompt. This prompt may also include formatting directives, tone parameters, and safety rules to guide the response from the AI model. The prompt is then transmitted to the Gen AI model API wrapper 210, which is configured to receive the prompt, determine an appropriate large language model from among the available models of the Gen AI model 112, and submit the prompt for execution. The Gen AI model API wrapper 210 may interface with hosted or external Gen AI models of the Gen AI model 112, and select a model based on usage quotas, performance characteristics, or content domain specialization.

Upon completion, the selected model of the Gen AI model 112 may return a generated response to the Gen AI model API wrapper 210, which validates and parses the output, and forwards the response back to the chat service 208. The chat service 208, in turn, returns the finalized response to the chat engine 206, which manages session flow and prepares the response for formatting by the chat interface 204 and display in the user chat interface 106. During this process, the prompt engine 402 may also log interaction metadata—including the original query, retrieved vectors, selected Gen AI model, generated response, response confidence score, and user context—into the historical database 118. This stored data may later be used for auditing, accuracy benchmarking, prompt tuning, and reinforcement learning strategies.

The chat service 208 may further include analyzer tools 406, which may be configured to assess system performance, detect anomalies, and provide operational insights. These tools may monitor metrics such as response latency, retrieval relevance scores, Gen AI model usage statistics, and user engagement levels. In an example, the analyzer tools may also provide alerting capabilities when thresholds are exceeded, or when significant shifts in topic trends or failure patterns are detected.

The topic analysis engine 404, also included within the chat service 208, may be invoked when a user issues a topical query—e.g., “What are the top issues other stores are asking about?”—via the topic analysis user interface 504 shown in FIG. 5. In response, the topic analysis engine 404 may retrieve historical questions from the historical database 118, convert them into vector embeddings using the same embedding model applied to documents and queries, and perform a clustering operation to group semantically related queries into high-level topics. These clusters may represent frequently asked questions, emergent operational challenges, or enterprise-wide concerns.

Once clustered, the topic analysis engine 404 may identify the top-ranked topics based on query frequency, recent spikes, or assigned weights. The topic clusters may then be submitted to the Gen AI model API wrapper 210 with a request for summarization, enabling the Gen AI model 112 to generate a digestible topic summary. The resulting summaries may be returned to the topic analysis engine 404, logged to the historical database 118, and presented to the end user via the topic analysis user interface 504. The topic analysis engine 404 may operate on a recurring schedule or on-demand, ensuring that both real-time trends and longer-term patterns are available to decision-makers and suers.

FIG. 5 illustrates an example data flow 500 showing processing of help requests and aggregation and analysis of topical information requests received at the store employee assistance application 104 of FIG. 1, according to an example embodiment.

The help AI user interface 502 and the topic analysis user interface 504 may represent two interactive components of the store employee assistance application 104, each configured to facilitate different types of information access within the broader store employee assistance platform 104. Both interfaces may operate through the same user chat interface 106, allowing users to submit free-form questions, request trending topics, or interact with curated content summaries. In an example, these interfaces may be integrated into a unified user experience accessible via mobile or desktop environments, enabling dynamic interaction with both individual assistance features and enterprise-level topic exploration.

The help AI user interface 502 may serve as the default interaction mode for users seeking immediate guidance or answers to specific procedural, policy, or operational questions. This interface may present a text input field powered by the user chat interface 106, through which users may submit natural language queries such as “How do I override a price?” or “Can I move an endcap without approval?” Once submitted, these queries may be processed as described in FIGS. 2-4, flowing through the chat interface, prompt engine, and large language model pipeline to return a role-and context-specific response tailored to the employee's job function, store location, and access rights.

The topic analysis user interface 504, in contrast, may allow employees or managers to explore high-level themes and frequently asked questions emerging across the organization. In one example, a user may explicitly enter a query such as “What are the top topics this week?” via the user chat interface 106, which may be interpreted and routed to the topic analysis engine 404 for clustering, ranking, and summarization. In an alternate implementation, the store employee assistance application 104 may present a selectable “Top Topics” panel or dashboard, which is periodically and automatically updated based on aggregated real-time interaction data analyzed by the topic analysis engine 404. This panel may include clickable summaries of top questions, enabling employees to view popular topics without having to initiate a manual query.

The help AI user interface 502 and topic analysis user interface 504 thus provide complementary access modes within the same platform—one optimized for targeted, on-demand assistance and the other for awareness of broader operational trends. In the sections that follow, the workflow is described in two parts: (1) when a help question is received via the help AI user interface 502, and (2) when a top topic request is received via the topic analysis user interface 504.

In some examples, when a user submits a natural language query using the help AI user interface 502—functionally accessible through the user chat interface 106 of the store employee assistance application 104—the question is received by the backend chat interface 204 and subsequently passed to the chat engine 206. The chat engine 206 may then invoke the prompt engine 402, which is responsible for retrieving relevant enterprise knowledge and formatting the input for submission to a generative AI model. As part of this process, the prompt engine 402 may query the vector database 116 within the data store 114, retrieving semantically similar document chunks that were previously ingested and vectorized through the data ingestion pipeline described in FIG. 3.

In some examples, the prompt engine 402 may also access the historical database 118 in parallel, retrieving records of past interactions involving similar topics, users with matching roles, or comparable procedural domains. This may support contextual continuity, reinforce prompt quality, and improve retrieval precision through informed augmentation of the current prompt. After assembling the retrieved information, the prompt engine 402 formats a complete prompt—including the original user question, relevant document chunks, session metadata (e.g., user identity, role, store location), and instruction formatting—and forwards it to the Gen AI model API wrapper 210 for model selection and processing.

Simultaneously, the prompt engine 402 may send a copy of the new question metadata to streaming data brokers 506. The streaming data brokers 506 may be implemented using real-time messaging or data pipeline frameworks (e.g., Apache Kafka, AWS Kinesis), and are configured to forward incoming question data to downstream consumers for asynchronous processing. One such consumer is the topic analysis engine 404, which receives the new question, applies vector embedding to it using a shared embedding model, and stores the resulting vector representation in the historical database 118. This enables the topic analysis engine 404 to continuously update and refine its internal clustering of top enterprise topics based on evolving usage patterns.

Although the submitted help request is not itself a request for trending topics, routing the question through the topic analysis engine 404 allows the system to capture and track new data points that may later contribute to the generation of top topic summaries. The topic analysis engine 404 may use this data to periodically identify and cluster similar questions across the organization and submit the top clusters to the GenAI model API wrapper 210 for summarization, which are then used to populate the topic analysis user interface 504.

Returning to the primary workflow, the GenAI model API wrapper 210 submits the help-related prompt to a selected GenAI model 112, such as GPT-4, Claude, or LLaMA, depending on enterprise configuration and model capabilities. Once the Gen AI model 112 generates a response, the response is sent back to the Gen AI model API wrapper 210, which parses and validates the result before forwarding it to the chat service 208. The chat service 208 then returns the response to the chat engine 206, which manages session tracking, and ultimately passes the response to the chat interface 204 for display to the employee via the help AI user interface 502. The prompt engine 402 may also store metadata—including the original question, vector hits, selected documents, model output, and user feedback—in the historical database 118 for future refinement, auditing, or topic analysis.

In some examples, when a request for top topics is issued—either as a direct user query via the user chat interface 106 or as part of a scheduled or on-demand update to a “Top Topics” panel within the store employee assistance application 104—the request is routed through the topic analysis user interface 504 depicted in FIG. 5. The topic analysis user interface 504 interface may be used by store employees, managers, or enterprise administrators to gain visibility into trending or frequently asked questions across the retail organization. The request may be presented in natural language form (e.g., “What are the top questions this week?”) or triggered through user interaction with a selectable interface element.

The request is received by the backend chat interface 204 and passed to the chat engine 206, which recognizes the query as a topic analysis request based on classification rules or prompt labels. Rather than initiating the standard prompt generation and document retrieval path, the chat engine 206 routes the request to the topic analysis engine 404, a subsystem within the chat service 208. The topic analysis engine 404 is configured to analyze question traffic received across the help AI user interface 502, which is continuously fed into the system via streaming data brokers 506. The streaming data brokers 506 provide a high-throughput, low-latency data stream of user-submitted questions to the topic analysis engine 404, ensuring that topic identification is based on the most recent and relevant queries.

Upon receiving the request, the topic analysis engine 404 may read stored question data and associated vector embeddings from the historical database 118, where previously submitted help queries have been logged and encoded. Using clustering algorithms—such as k-means, DBSCAN, or density-based approaches—the engine groups similar questions into topic clusters, each representing a semantically cohesive theme. Examples may include clusters like “Store opening procedures,” “POS system troubleshooting,” or “Vendor delivery protocols.”

Once top-ranked clusters are identified based on frequency, recency, or organizational interest weightings, the topic analysis engine 404 compiles representative vectors and summary labels for each topic. These topic summaries, or the raw clusters themselves, are then submitted to the GenAI model API wrapper 210, which selects an appropriate model from the GenAI model 112 to transform each topic into a natural language summary. The use of a generative model allows the system to generate high-level, casily digestible summaries from diverse question clusters.

The generated summaries are returned from the GenAI model API wrapper 210 to the topic analysis engine 404, which formats the output and stores it in the historical database 118 for subsequent reuse. If the request originated from a user, the topic analysis engine 404 returns the summaries to the chat engine 206, which passes the content through the chat interface 204 for display within the user chat interface 106. If the request was part of an automated update routine (e.g., scheduled content refresh for a dashboard or in-app widget), the topic analysis engine 404 may directly push the content to the store employee assistance application 104 for rendering in the “Top Topics” section of the interface.

This workflow enables dynamic and context-sensitive discovery of enterprise-wide concerns and frequently asked questions, equipping employees with both proactive insights and reactive support based on real-time interaction trends.

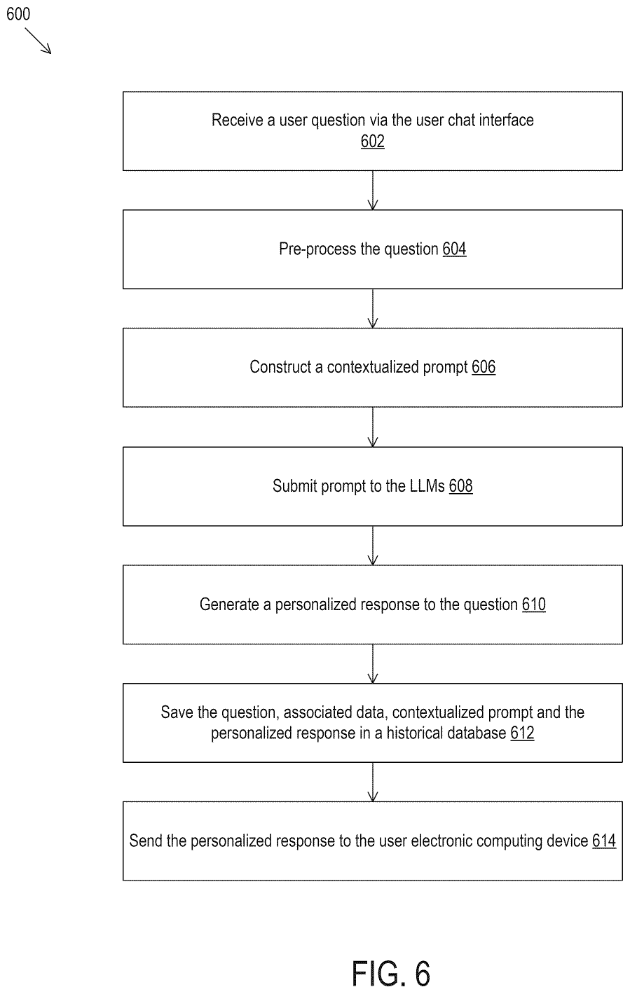

FIG. 6 illustrates an example method 600 for responding to a user question with a personalized response, in accordance with an example embodiment of the store employee assistance system 100 from FIG. 1. The example method 600 includes operations 602-614 that describe the process of receiving a user question, retrieving appropriate enterprise documents related to the user question and providing a personalized response to the user question with the assistance of the Gen AI model 112.

In example operation 602 of FIG. 6, the store employee assistance platform 110 receives a question submitted by a user through the user chat interface 106 of the store employee assistance application 104, operating on a user electronic computing device 102. In one example, the user may be an employee of a retail enterprise—such as a sales associate, team lead, or supervisor—who submits a help-related inquiry seeking procedural, operational, or policy-based guidance.

In some examples, the question may be submitted in natural language form and routed to the backend platform through the chat interface 204, which interfaces directly with the user chat interface 106. The store employee assistance platform 110 may associate the received question with metadata identifying the user, including role, store location, and session attributes. This metadata may be captured automatically as part of the platform's communication session and may be used in downstream operations to tailor the system's response based on the user's context.

Following user identification, the store employee assistance platform 110 may initiate additional pre-processing of the received question to prepare it for downstream semantic retrieval and prompt generation. In one example, the chat interface 204 or chat engine 206 may normalize the input by trimming whitespace, correcting formatting inconsistencies, converting characters to a standard encoding, and standardizing punctuation. The system may also tokenize or segment the question, apply basic language filtering, and encode it into an intermediate representation suitable for matching against vectorized enterprise content. This pre-processing ensures that the query is syntactically and structurally optimized for embedding comparison and improves the effectiveness of vector similarity searches and prompt composition in subsequent operations.

In example operation 606, the store employee assistance platform 110 may construct a contextualized prompt based on the pre-processed user question and the associated session metadata collected in operation 604. The prompt is generated by the prompt engine 402, which operates within the chat service 208, and is responsible for assembling all necessary components required to produce a role-specific, context-aware query suitable for submission to the Gen AI model 112.

In one example, the prompt engine 402 integrates the cleaned and tokenized question text with the user's identity information—including job title, department, store location, and access permissions—to ensure the resulting response is relevant to the user's operational context. The system may embed this metadata directly into the prompt structure as explicit context instructions or may use the metadata to retrieve role-specific examples or formatting guidelines from stored templates. The prompt engine 402 may also incorporate document chunks retrieved from the vector database 116, which contain enterprise-authored content semantically related to the question. These retrieved chunks are selected using the same embedding model used during document ingestion (as described in FIG. 3) and may be filtered to ensure compliance with the user's access level.

In some examples, the final prompt may include the following elements: (i) the pre-processed user query, (ii) relevant enterprise knowledge snippets, (iii) user identity attributes, and (iv) formatting and tone instructions (e.g., “respond with concise procedural steps appropriate for a retail floor associate”). By combining these inputs, the store employee assistance platform 110 may ensure that the prompt submitted to the GenAI model 112 is sufficiently rich in context to yield a response that is not only accurate but also actionable and appropriate to the specific user's role and responsibilities.

In example operation 608, the store employee assistance platform 110 may submit the contextualized prompt generated in operation 606 to the GenAI model 112 via the GenAI model API wrapper 210. The GenAI model API wrapper 210, operating as an intermediary component between the prompt engine 402 and the generative model interface, may format, route, and manage the submission of the prompt to the appropriate large language model instance.

In one example, the GenAI model API wrapper 210 may receive the structured prompt, verify its integrity, and apply any necessary model-specific transformations, such as tokenization schemes, system-level instruction wrapping, or truncation to comply with input token limits. The GenAI model API wrapper 210 may also determine which Gen AI model 112 to use based on preconfigured routing logic that considers model performance, latency, query domain, or enterprise usage quotas.

In an example, the GenAI model API wrapper 210 may be implemented using an interface such as described in U.S. Provisional Patent Application No. 63/561,109, filed on Mar. 4, 2024, and U.S. application Ser. No. 19/070,120, filed on Mar. 4, 2025, the disclosures of which is hereby incorporated by reference in its entirety.

Once the appropriate model is selected, the GenAI model API wrapper 210 may transmit the prompt to the GenAI model 112 for processing. This submission includes the user's question, identity-based context, and retrieved enterprise content to ensure that the AI model has sufficient information to generate a personalized and context-relevant response. After the model completes its inference, the generated response is returned to the Gen AI model API wrapper 210, which validates the output format and prepares the response for reintegration into the broader response delivery workflow.

In example operation 610, the GenAI model 112, as part of the store employee assistance platform 110, generate a contextually relevant response based on the structured prompt received via the GenAI model API wrapper 210. The GenAI model 112 receives a prompt that includes the user's original question, retrieved enterprise content from the vector database 116, and identity-linked metadata—such as the user's job title, access permissions, and store location—ensuring that the response aligns with the specific context of the request.

Using its trained language modeling capabilities, the GenAI model 112 may formulate a response that is both semantically appropriate and operationally relevant to the identified user. For example, the GenAI model 112 may generate distinct responses for a supervisor and a restocker, even if the underlying question is similar, by incorporating access-aware instructions and enterprise-specific nuances provided in the prompt. Once the response is generated, the GenAI model 112 may send the output back to the GenAI model API wrapper 210, which passes the response through the chat service 208, and then to the chat engine 206. The chat engine 206 may manage the response within the active session and coordinate with the chat interface 204 to deliver the output to the user chat interface 106 as described in operations 612-614 below.

In example operation 612, the store employee assistance platform 110, through the chat engine 206, stores the complete interaction record in the historical database 118. The record includes the user-submitted question received in operation 602, the contextual information and metadata collected in operation 604, the fully assembled prompt generated in operation 606, and the personalized response generated by the GenAI model 112 in operation 610. The chat engine 206 may also capture system-level metadata, such as timestamps, session ID, selected embedding results from the vector database 116, and the version of the Gen AI model 112 used to formulate the response.

This historical logging enables long-term tracking of user interactions, supports platform analytics, and contributes to future improvements in prompt quality and model selection. The recorded data may be used by the topic analysis engine 404 to identify recurring themes or high-frequency queries, and may serve as a benchmark dataset for evaluating the accuracy, consistency, and relevance of responses provided by the system over time. Completion of this logging step ensures that the personalized response is fully traceable and linked to the originating user context.

In example operation 614, the store employee assistance platform 110, through the chat interface 204, transmits the personalized response to the user electronic computing device 102 for presentation within the user chat interface 106. The response, having been generated by the Gen AI model 112 and routed through the GenAI model API wrapper 210, chat service 208, and chat engine 206, is formatted and finalized by the chat interface 204 to ensure clarity, structure, and compatibility with the user's display environment.

In one example, the transmitted response may include role-specific language, procedural instructions, or embedded reference links, depending on the user's identity attributes captured carlier in the workflow. The user chat interface 106 may then render the response within the store employee assistance application 104, allowing the user to view the output and take action.

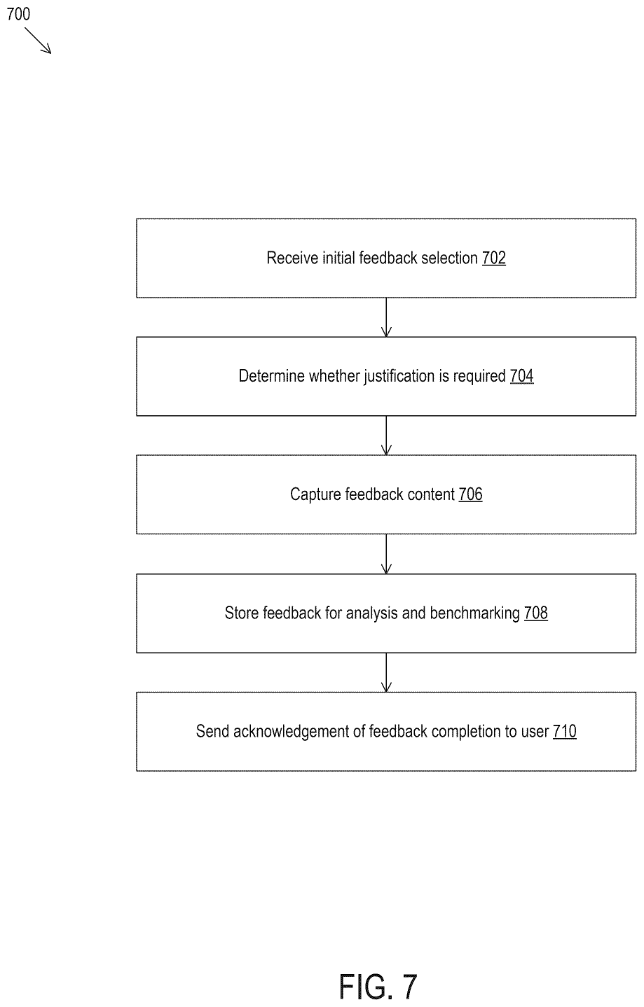

FIG. 7 illustrates and example method 700 of managing a feedback request provided by the store employee assistance platform 110, in accordance with an example embodiment. The example method 700 may include operations 702-710.

As described in operation 614 of FIG. 6, in response to receiving a question from the user, the store employee assistance platform 110 may present a generated response to the user via the user chat interface 106 of the store employee assistance application 104, displayed on the user electronic computing device 102. The response, generated by the Gen AI model 112 and routed through the platform as described in FIG. 6, appears in the same conversational thread in which the original question was submitted. Alongside the response, the user chat interface 106 may present interactive feedback controls—such as thumbs-up and thumbs-down icons—to enable the user to provide an initial evaluation of whether the response was helpful in addressing the question.

In example operation 702, the store employee assistance platform 110 may receive an initial feedback selection from the user chat interface 106. In one example, the user may select either the thumbs-up icon to indicate approval or the thumbs-down icon to indicate disapproval of the response. Other types of selections are also possible, including an emoji to indicate the user's reaction to the response. The feedback selection may be captured directly within the user chat interface 106 and transmitted to the backend components of the store employee assistance platform 110 via the chat interface 204. The initial feedback serves as a general signal regarding the perceived helpfulness or relevance of the AI-generated answer and forms the basis for potential follow-up steps in the feedback capture workflow.

In example operation 704, the store employee assistance platform 110 may evaluate the initial feedback selection received from the user in operation 702 to determine whether a justification is required. This decision process may be performed by the chat engine 206, which may analyze the feedback input and apply predefined logic or policy criteria configured within the store employee assistance platform 110.

In one example, if the user submits a thumbs-down response indicating dissatisfaction with the generated answer, the platform may classify this as negative feedback and trigger a prompt for further explanation. The decision to request justification may depend on several factors, including the severity of the feedback (e.g., repeated negative inputs from the same user), the classification of the question topic (e.g., high-risk or compliance-related), or the role and access level of the user. For instance, negative feedback from a store manager on a critical operational procedure may carry higher priority for justification than feedback on routine topics.

Conversely, if the user selects a thumbs-up, or if certain conditions are met (e.g., anonymous session, transient low-sensitivity queries), the platform may determine that no justification is necessary. The result of this evaluation governs whether the platform proceeds to collect additional feedback in operation 706 or ends the feedback flow for this session.

In example operation 706, the store employee assistance platform 110 proceeds to capture detailed feedback content from the user after determining in operation 704 that justification is warranted based on the initial feedback selection. In one example, this occurs when a user provides a thumbs-down response in operation 702 and the platform evaluates that additional insight is necessary—such as when the topic is critical, the response deviated significantly from expected content, or the user holds a role with high operational impact (e.g., store manager or department lead). If the platform had determined in operation 704 that no additional justification was needed, the method would have concluded without invoking operation 706.

Upon determining that additional feedback is required, the store employee assistance platform 110 prompts the user—via the user chat interface 106—to provide a brief explanation describing why the response was unsatisfactory. The platform may display a message such as “Would you like to share why this response didn't meet your needs?” along with a free-text input field. The user may respond with comments such as “The answer didn't match our store's process,” “The policy referenced is outdated,” or “This only applies to managers, and I'm a floor associate.”

The feedback content may be captured as unstructured text and transmitted to the backend through the chat interface 204, where it is associated with the original question, generated response, session metadata, and user identity. In one example, the platform may also log the timestamp of the feedback submission, the feedback type, and any follow-up interactions.

In example operation 708, the store employee assistance platform 110 may store the feedback content captured in operation 706—along with the associated contextual data—for purposes of future analysis, benchmarking, and system improvement. The feedback record may include the original user-submitted question, the response generated by the Gen AI model 112, the user's initial feedback selection (e.g., thumbs-up or thumbs-down), any optional justification provided, and session metadata such as user identity, job title, store location, timestamp, and session ID.

The received data may be stored in a designated section of the historical database 118, or in a separate feedback repository within the data store 114, where it can be accessed by internal analytics tools, administrative dashboards, or system auditing processes. In one example, feedback records may be used to identify recurring dissatisfaction patterns, evaluate the accuracy and role-appropriateness of responses, or guide the retraining and fine-tuning of the Gen AI model 112. By preserving both qualitative and quantitative aspects of the feedback interaction, the store employee assistance platform 110 enables robust benchmarking of performance over time and supports continuous refinement of its AI-driven assistance capabilities.

In example operation 710, the store employee assistance platform 110 may transmit a confirmation response to the user chat interface 106 to indicate that the feedback process has been completed. The confirmation serves to acknowledge the user's input—whether it was a simple thumbs-up or thumbs-down in operation 702, or a more detailed justification provided in operation 706—and to close the feedback interaction in a clear and user-friendly manner.

In one example, the platform may present a short message such as “Thank you for your feedback,” “Your input has been recorded,” or “We appreciate your help improving our service.” The message is delivered through the chat interface 204 and displayed on the user electronic computing device 102 within the store employee assistance application 104. This final interaction assures the user that their response has been processed and logged, and provides a seamless transition back to the standard interface where additional questions may be asked or new tasks initiated.

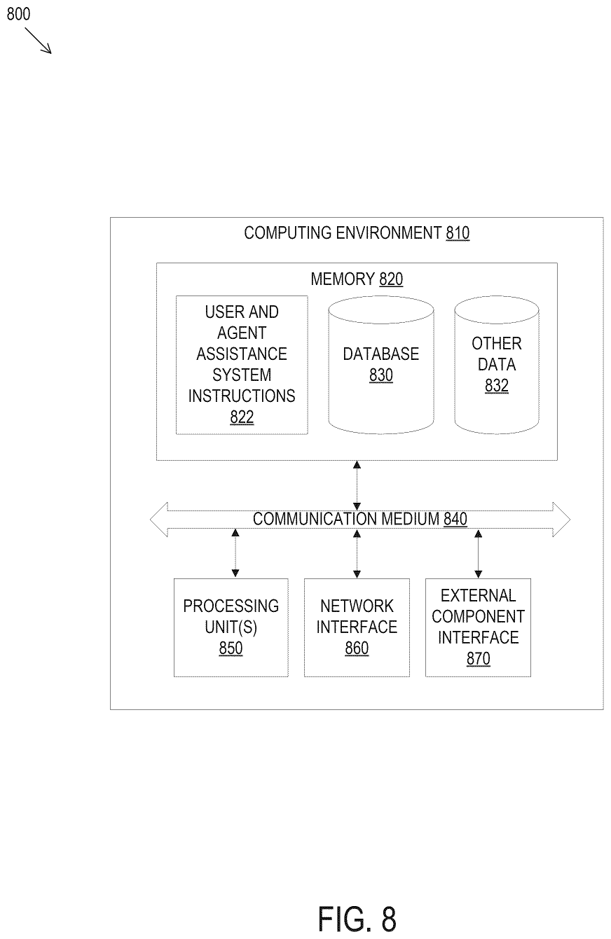

FIG. 8 illustrates an example block diagram of a virtual or physical computing system 800. One or more aspects of the computing system 800 can be used to implement the processes described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 801. The network 801 is a computer network, such as an enterprise intranet and/or the Internet. The network 801 can include a LAN, a Wide Area Network (WAN), the Internet, wireless transmission mediums, wired transmission mediums, other networks, and combinations thereof. The computing system 800 may connect to the network 801 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

The disclosed computing system provides a physical environment with which aspects of the system described herein may be implemented. It is noted that the disclosure computing system may be used to implement, e.g., data storage devices hosting enterprise information, one or more host computing servers used to provide associated services, or end-user devices, such as a personal computing system having a browser installed thercon, or a mobile device having either a browser or mobile application installed therein.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of generative AI systems, technologies disclosed herein are applicable to data and methods for operation of a retail website and/or retail supply chain generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A store employee assistance system comprising:
a chat interface configured to receive a query from a user via a user application;
a vector database configured to store vectorized enterprise data associated with an enterprise;
a chat service communicatively coupled to the chat interface and the vector database, the chat service configured to:
determine one or more user attributes and contextual information associated with the query;
retrieve relevant content from the vector database based on semantic similarity between the query and the vectorized enterprise data;
generate a prompt combining the query and the relevant content;
a generative artificial intelligence system configured to formulate a response to the query based on the prompt, the user attributes, and the contextual information; and
wherein, the chat service is further configured to provide the response to the chat interface for display to the user.

2. The store employee assistance system of claim 1, wherein the one or more user attributes includes at least one of: identity of the user, a role of the user within the enterprise and access rights associated with the user.

3. The store employee assistance system of claim 1, wherein the contextual information comprises at least one of a user's location, time stamp, context of the question posed, or enterprise-specific data.

4. The store employee assistance system of claim 2, wherein the response is customized by the generative artificial intelligence system to align with one or more of: the role of the user within the enterprise and with the access rights associated with the user.

5. The store employee assistance system of claim 1, wherein the enterprise is a retail enterprise, and the user is an employee of the retail enterprise.

6. The store employee assistance platform of claim 1, wherein the generative AI system includes one or more large language models (LLMs) or multimodal models.

7. The store employee assistance system of claim 1, further comprising a topic analysis engine configured to:
receive a plurality of queries over a period of time;
analyze the received queries to identify trending topics across the plurality of queries;
generate topic clusters based on semantic similarity between the plurality of queries;
submit the topic clusters to the generative AI system for summarization; and
provide summarized topic analysis results to the user via a topic analysis interface.

8. The store employee assistance system of claim 1, further comprising a feedback interface configured to:
receive an initial feedback selection from the user regarding the response;
determine whether additional feedback justification is required;
when it is determined that the additional feedback justification is required, prompt the user to provide detailed feedback content explaining why the response was unsatisfactory; and
store the feedback selection, any provided detailed feedback content, and associated contextual data in a historical database for analysis and system improvement.

9. The store employee assistance system of claim 8, wherein the determination of whether the additional feedback justification is required is based on at least one of: the type of initial feedback selection, a classification of the question topic, the user attributes, or predefined policy criteria.

10. The store employee assistance system of claim 1, wherein the chat service is further configured to:
store, in a historical database: the query, the response, session metadata comprising one or more of: user identity, timestamp, and session identifier, the relevant content used to generate the response, and model metadata associated with the generative AI system;
wherein the stored data is used for at least one of: performance monitoring, analytics, topic clustering, or iterative improvement of prompt engineering.

11. A method for providing assistance to users, the method comprising:
receiving, at a chat interface, a query from a user via a user application;
storing vectorized enterprise data associated with an enterprise in a vector database;
determining, by a chat service, one or more user attributes and contextual information associated with the query;
retrieving, by the chat service, relevant content from the vector database based on semantic similarity between the query and the vectorized enterprise data;
generating, by the chat service, a prompt combining the query and the relevant content;
formulating, using a generative artificial intelligence system, a response to the query based on the on the prompt, the user attributes, and the contextual information; and
providing the response to the chat interface for display to the user.

12. The method of claim 11, wherein the one or more user attributes includes at least one of: identity of the user, a role of the user within the enterprise and access rights associated with the user.

13. The method of claim 12, wherein the response is customized by the generative artificial intelligence system to align with one or more of: the role of the user within the enterprise and the access rights associated with the user.

14. The method of claim 11, wherein the contextual information comprises at least one of a user's location, time stamp, context of the question posed, or enterprise-specific data.

15. The method of claim 11, wherein: the enterprise is a retail enterprise, and the user is an employee of the retail enterprise.

16. The method of claim 11, further comprising parsing, vectorizing, and storing the relevant data into the vector database.

17. The method of claim 11, wherein the generative AI system includes one or more LLMs or multimodal models.

18. The method of claim 11, further comprising:
storing, in a historical database: the query, the response, session metadata comprising one or more of: user identity, timestamp, and session identifier, the relevant content used to generate the response, and model metadata associated with the generative AI system;
wherein the stored data is used for at least one of: performance monitoring, analytics, topic clustering, or iterative improvement of prompt engineering.

19. A store employee assistance system comprising:
a chat interface configured to receive a query from a user via a user application;
a document uploader configured to parse, vectorize, and store enterprise data associated with an enterprise into a vector database.
a chat service communicatively coupled to the chat interface and the vector database, the chat service configured to:
determine an identity of the user, a role of the user within the enterprise and access rights associated with the user
retrieve relevant content from the vector database based on semantic similarity between the query and the vectorized enterprise data;
generate a prompt combining the query and the relevant content;
a generative artificial intelligence system configured to formulate a response to the query based on the prompt, the user attributes, and the contextual information wherein the response is customized by the generative artificial intelligence system to align with one or more of: the role of the user within the enterprise and with the access rights associated with the user; and
wherein, the chat service is further configured to:
store, in a historical database: the query, the prompt, the response, session metadata comprising one or more of: user identity, timestamp, and session identifier, the relevant content used to generate the response, and model metadata associated with the generative AI system; and
provide the response to the chat interface for display to the user on the user application.

20. The store employee assistance system of claim 19, further comprising a feedback interface configured to:
receive an initial feedback selection from the user regarding the response;
determine whether additional feedback justification is required, wherein the determination of whether the additional feedback justification is required is based on at least one of: the type of initial feedback selection, a classification of the question topic, the user attributes, or predefined policy criteria;
when it is determined that the additional feedback justification is required, prompt the user to provide detailed feedback content explaining why the response was unsatisfactory; and
store the feedback selection, any provided detailed feedback content, and associated contextual data in a historical database for analysis and system improvement.
